(19) United States
(12) Patent Application Publication
(10) Pub. No.: US 2010/0274757 A1
(43) Pub. Date: Oct. 28, 2010

(54) DATA LINK LAYER FOR DATABASES

(76) Inventor: Stefan Deutzmann, Wien (AT)

Correspondence Address: KF ROSS PC, 5683 RIVERDALE AVENUE, SUITE 203 BOX 900, BRONX, NY, 10471-0900, US

(21) Appl. No.: 12/682,652

(22) PCT Filed: Jun. 16, 2008
(86) PCT No.: PCT/EP08/04822

§ 371 Date: May 6, 2010

(30) Foreign Application Priority Data
Nov. 16, 2007 (DE) 10 2007 057 248.6

(51) Int. Cl. G06F 17/30

(52) U.S. Cl. 707/610; 707/705; 707/E17.044; 707/E17.005

(57) ABSTRACT

Method for effecting access to databases and/or data arrays and/or applications (C) in a data processing installation and/or in a network of data processing installations, wherein the databases and/or data arrays and/or applications (C) have an explicit address associated with them, particularly an IP address, a server name, a path name and/or a file name or the like, wherein each database and/or each data array and/or each application (C) has an alias uniquely associated with it and at least one association entity (B) is provided in which the association between alias and address is stored and can be retrieved therefrom, and wherein a connection entity (V) is provided which, in the event of attempted access to databases and/or data arrays and/or applications (C), uses the alias to retrieve the address from the association entity (B) and then uses the address obtained from the association entity to access the databases and/or data arrays and/or applications (C).

The invention concerns a method of providing access to databases and/or data arrays and/or applications in a data-processing system and/or in a network of data-processing systems where an explicit address is associated with the databases and/or data arrays and/or applications, in particular an IP address, a server name a path name and/or a file name or the like and to a data-processing system with an application for executing the method.

Several applications exist based on a platform for databases. The term “application” means the actual program, as well as the data stored by this program. The data can be stored within the application or outside it. It is implied that access is provided by means of the application. These applications are connected with each other for certain functions in order to use the data of a different application. Thus the calling application must know where the application that is to be polled can be found and how the data can be polled. As over time, many applications with many reciprocal interconnections result, maintenance of each individual interconnection is not possible. If it is necessary to change the application that is to be polled (for example a different server, a different database name, a different field structure, etc.), changes in the calling applications must be avoided.

Moreover, access to the applications should be as efficient as possible in order to keep the number of accesses and thus the server load as low as possible.

In many cases, server names and database names of applications that are to be polled are hard-coded in the program code of the calling application. Solutions are known for replacing these server and database names. But with that, the fundamental problem of fixed access paths is still not fixed. Even solutions are known for storing configurations in every application and to then indicate in them the server name and database name or a platform-specific address for other applications that are to be polled. If an application that is to be polled is changed (for example migration to a different server), the configuration in each calling application must be changed at great effort. Thus, there is the risk of not knowing all calling applications.

Retrieval of the data itself is performed by access at the field level. For this, the desired dataset must be found, opened and then the field must be polled in the dataset. This process is—dependent on the platform used—not optimal with respect to performance. Known solutions dedicate themselves to the problem of coupling different systems and databases. Thus way, a “translation” of respectively specific properties into a more general form or into specific properties of another system is in the foreground.

It is the object of the invention to provide a method and a data-processing system by means of which the mentioned disadvantages are overcome and, in particular, that the adaptation to a certain application in complex systems to a changed data structure or server structure is prevented.

This problem is solved in accordance with the invention by a method of claim 1 and by a data-processing system according to claim 10.

This way, it is particularly advantageous that in the method of performing access to databases and/or data arrays and/or applications in a data-processing system and/or in a network of data-processing systems, where the databases and/or data arrays and/or applications have an associated, explicit address, in particular an IP address, a server name, a path name and/or a file name or the like, and each database and/or each data array and/or each application has an explicitly associated alias and at least one association instance is provided in which the allocation of an alias to an address is stored and can be retrieved by it, and that a data-link instance is provided that, during an attempted access to the databases and/or data arrays and/or applications, polls the address by using the alias from the association instance and then, by using the address received by the association instance, accesses the databases and/or data fields and/or applications.

The method in accordance with the invention is not dedicated to the translation problem of various systems, even though coupling of the method with a translation procedure is conceivable. In the described method, an application is only identified within a system by means of its alias. Hence the term “system” means that the applications use the same platform, i.e. they store their data in different databases of the same manufacturer. The databases can run on the same or on different hardware. The more databases and/or servers are affected, the larger is the advantage of the method. A data-link layer, i.e. a data-link instance converts the alias into a physical application, i.e. the actual address. The data-link layer offers certain interfaces to the applications in order to poll other applications. In a central configuration, i.e. in an association instance, which physical application is hidden behind an alias is stored.

The method on which the invention is based expands and improves the principle of simple, physical localization of the resource, such as, for example, the known DNS systems by, in that in addition to finding the database, a universal method is described in order to be able to access data of a target resource from its storage structure independently and efficiently. The independence of structure even goes so far that at the access interface, additional data can be offered without having to change existing accesses.

WebServices, for example, do not allow this kind of flexibility. Further, the access technology is identical for all applications that use the method. Thus, advantages result with respect to simplified programming of the interfaces, their maintenance, expandability and changeability, as well as performance during the run time

Additional advantageous embodiments of the invention are detailed in the dependent claims.

Preferably, the association instance is a centrally stored instance, in particular in the form of a database. Alternatively, the association instance can be formed by synchronized copying on a majority of data-processing systems.

In a preferred embodiment of the method in accordance with the invention, one alias is respectively associated with each accessing application as well as each application that is to be accessed. The association of the alias to the application or address is stored in the association instance as central configuration and can be retrieved there.

Preferably, individual data arrays and/or data array contents of a database are indexed.

It is also possible that, when starting, each application first polls its own alias by polling in the association instance.

Preferably, data contents of a database are returned to the calling application by means of the data-link instance.

The data-link instance can be provided with a data-processing instance that can process the data received prior to a transfer to the calling application. Alternatively or cumulatively, the data-link instance can be provided with a data buffer that can store the data that was received at least temporarily. The progression of the method in a particularly preferred embodiment is described in the following.

Indices are used for tapping individual data so that access of the index can be utilized at optimal performance, and that it does not take place at the array level. In addition, by means of the index, the data can even be made available in a pre-processed form, in order to thus reduce access times. Access to the index also takes place by means of the data-link layer. Thus, the data are masked with an alias in order to decouple the data names that can be polled from the underlying field names. A central configuration stores the indices available for the respective data aliases.

In the method described, applications call themselves reciprocally by the respective alias. In case of changes, for example, at the server and/or the name of an application, only

alias—physical application (address)

needs to be adapted at one position (the central configuration) of the allocation in order to immediately convey all retrievals of this application to the new physical application. This advantage becomes larger as more applications communicate with each other.

By means of this index and its masking by aliases, a decoupling from the actual field names is achieved. If the field names of the application to be called change, only the index structure must be adapted. The alias, which identifies the data element to the outside, remains unchanged. Thus, no changes are necessary in calling applications. In addition, data elements can be added to the index at any position without endangering existing polls of the index (naturally, the alias definition must correctly show the index structure).

The method works with double masking, i.e. the explicit association of alias with application or address and alias to data element: application masking and data masking. Access to applications and data takes place by means of a data-link layer, i.e. by a data-link instance. All information for masking is stored in a central configuration, i.e. in an association instance. This configuration is stored in such a way that it can be accessed by all applications in order to read data out of it. Conceivable variants of embodiments for these central configurations are:

A centrally stored instance

A synchronized copy on all servers

Algorithmically determinable instances

As these are only background applications, the only limitation is that all applications must have access. The central configuration data only have a small extent and are subject to few changes. For this reason, access to this configuration data can happen very fast, so that no noticeable reduction in performance is to be recorded. The entire implementation of the masking is hidden in the intermediate layer and is used by each application. Depending on whether access is to be to the application itself or if the data is to be accessed, the masking is to be implemented and configured accordingly. The intermediate layer offers powerful interfaces by means of which access to the data or the application takes place.

Three embodiments according to the invention of the method or system are shown in the figures and are explained in the following. Therein:

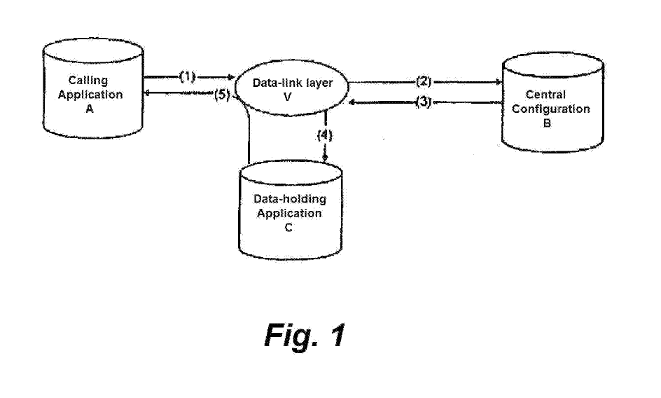

FIG. 1 is a schematic diagram of the access of a calling application by means of the data-link layer of a data-containing application;

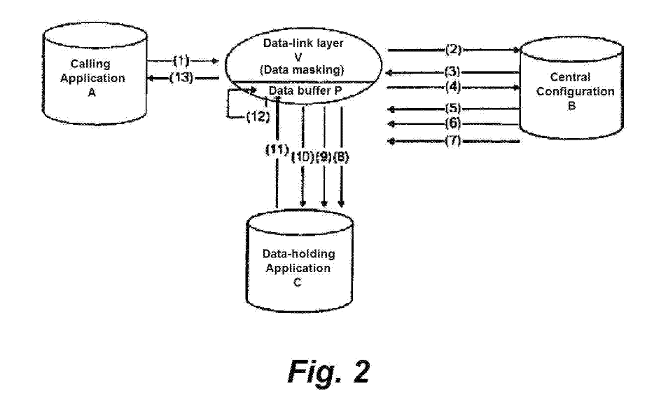

FIG. 2 is a schematic diagram of the access by a calling application by means of the data-link layer to certain data contents of a data-containing application;

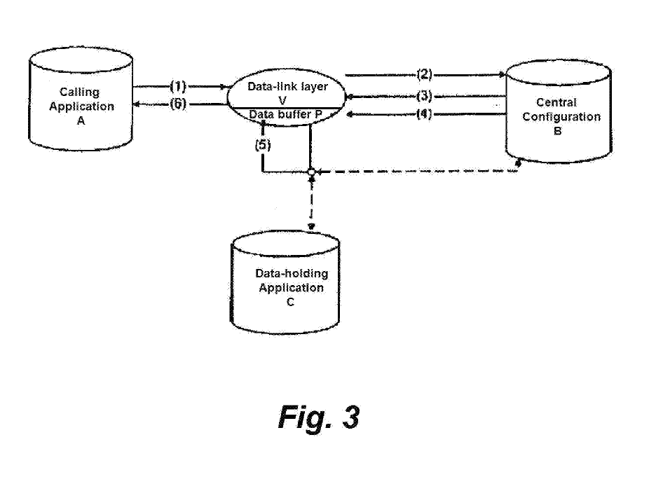

FIG. 3 is a schematic diagram of the access of a calling application by means of the data-link layer to complete datasets of a data-containing application.

Application masking takes place as shown in FIG. 1.

Each application has a mask registration consisting of two elements in the central configuration:
Alias of the application
Physical application (for example, server name and file name or other suitable parameters, that are required for calling the applications).

As an application starts, it determines its own alias by polling the alias pertaining to its physical location (actual address). As a result of this, it is possible for the application to determine its own “identity” and, for example, to provide this information in messages to other applications or to read additional configurations that concern it from the central configuration.

If an application wants to contact another application, it queries the physical application at the intermediate layer using the alias of the target application. The intermediate layer thereupon returns a corresponding access possibility. These functionalities are built into the intermediate layer in such a way that the affected applications no longer communicate directly with one another. The intermediate layer accepts all queries and answers of the affected applications and forwards them to the respective addressee. If one application calls another application, retrieval takes place according to the scheme illustrated in FIG. 1.

1. The calling application A polls data link V, during which it passes on the alias of the application C that is to be polled.

2. The data-link layer V queries the central configuration B, during which it passes on the alias of application C that is to be called.

3. From central configuration B, the physical application C that is associated with the alias is returned to the data-link layer V.

4. The data-link layer V calls the physical application C that is associated with the alias.

5. The data-link layer V returns the called application C, for example, as object to the calling application A.

Thus, in the calling application A, no physical data need be stored of any kind of the application C that is to be called. Communication takes place exclusively by means of the data-link layer V and can be completely masked behind the alias. Only in the central configuration B, must attention be paid to the correct linking of the alias and the physical application. If the called application C changes, this change is mapped in the central configuration. According to this mapping, all calling applications immediately use new physical applications without requiring additional changes in the calling applications.

The data masking is shown schematically in FIG. 2.

The masking of the data is an expansion of the application masking. For each application that makes data available to other applications, at least one index is established that contains a suitable search key as well as additional data. Thus, an index is not only an access path for the identification of certain data, but it helps the intermediate layer to actually read data from the called application. An application can have several indices, for example, to improve the performance of individual indices or to be able to illustrate different types of data.

For each index, a polling configuration consisting of the following elements is stored in the central configuration:
Name of the polling configuration for identification
Alias of the application from which the data is to be read
Name of the index of the application
List of alias names for the individual data elements represented by the index

In order to poll data from a different application, during polling, only the polling configuration that is to be used, the search key, as well as the alias of the desired data element must be specified. If an application calls data from a different application, polling takes place as illustrated in FIG. 2:

Application A calls data-link layer V in order to receive data from application C.

1. The data-link layer directs a query to the central configuration B with the name of the query configuration.

2. The central configuration B reports back the alias of application C which is to be queried.

3. The data-link layer V directs a query to the central configuration B with the alias of application C to be queried.

4. The physical application C associated with the alias is reported back from central configuration B.

5. The name of the index in the physical application C that contains the desired data is reported back From central configuration B.

6. A list with aliases of the data available in the index is reported back from central configuration B.

7. The data-link layer V accesses the physical application C from (5).

8. The data-link layer V accesses the index from (6).

10. The data-link layer V searches for the dataset in the index that fits the search key.

11. Application C supplies all of the index data from dataset (10) to the data-link layer V.

These data are stored in the data buffer P.

12. The data-link layer V extracts the data with the desired data-element alias from all of the index data in buffer P (11).

13. The data-link layer V supplies the desired data to the calling application A.

As the data-link layer V polls the data for the calling applications A from the source application C and thereby reads all of the index data (see step 11), the polled data can be placed in intermediate storage in the data buffer P of data-link layer V. If a new polling of data takes place for the same dataset, the data-link layer V can make the data available directly, i.e. without any new access to the central configuration B or the source application C. Thus, the more data are polled for a dataset, the more significant the performance gain in contrast to an access without the technology shown here.

In addition, in the data-link layer V, robust mechanisms are stored that capture data errors and thus prevent malfunctions in the calling application A.

On the basis of this method, additional technologies are possible. Thus, from the view of the calling application—prior to data polling—additional steps are offered in the data-link layer. If, for example, the same data continue to be needed again and again for various applications (for example, for a customer application customer name, customer address, etc.), the data-link layer can make a method available, which automatically supplies the desired data in their entirety. For this purpose, a definition stored in the central configuration is provided with data masking and a data-element alias list.

In order to obtain all data on the list, the calling application must direct a query to the data-link layer and thereby pass on the name of the configuration, as well as the search key. If this method is used, even large data queries can be done with minimum effort in the calling application. In addition, the advantages of application masking, as well as the advantages of data masking can be used to their fullest. If an application polls data in this way, the polling takes place as shown in FIG. 3:

1. Application A calls data-link layer V and passes on the configuration name, as well as the search key.

2. The data-link layer V requests the configuration from the central configuration B.

3. From central configuration B, the corresponding data masking is returned.

4. From central configuration B, the corresponding data-element alias list is returned.

5. The data-link layer V iterates via the data-element alias list. For each pass, it polls data by the above described method of data masking (illustrated by dotted lines), so the data buffer of the data-link layer V is used.

6. The data-link layer V returns all of the data that was selected to the calling application A.

Based on that, additional expansions are possible. Thus, the data-link layer can not only return to the calling application, is but process and only return the result. As a result, the network layer can make central tools available that can be used by several applications, can be centrally maintained and which utilize the advantages of application masking and data masking.

1. A method of executing access to databases or data arrays or applications in a data-processing system or in a network of data-processing systems, whereby the databases or data arrays or applications have an explicitly associated address, in particular an IP address, a server name, a path name or a file name or the like, wherein each database or each data array or each application has an explicitly associated alias and at least one association instance is provided, in which the association of alias to address is stored and can be polled by such, and that a data-link instance is provided that, on an attempted access to the databases or data arrays or applications, polls the address from the association instance by using the alias and then, by using the address obtained by using the association instance, accesses the databases or data arrays or applications.

2. The method according to claim 1, wherein the association instance is a centrally stored instance, in particular in the form of a database.

3. The method according to claim 1, wherein the association instance is formed by synchronized copying on a majority of data-processing systems.

4. The method according to claim 1 wherein each accessing application as well as each application to be accessed has a respective alias that is associated with it.

5. The method according to claim 1 wherein individual data fields or data field contents are indexed in a database.

6. The method according to claim 1 wherein each application first retrieves its own alias on starting by polling the association instance.

7. The method according to claim 1 wherein the data contents of a database are returned to the requesting application via the data-link instance.

8. The method according to claim 1 wherein the data-link instance is provided with a data-processing instance that is capable of processing the data received prior to a transfer to the calling application.

9. The method according to claim 1 wherein the data-link instance is provided with a data buffer that is suited to store the data received at least temporarily.

10. A data-processing system with an application for executing a method according to claim 1.
